(19) United States
(12) Patent Application Publication
(10) Pub. No.: US 2025/0314459 A1
(43) Pub. Date: Oct. 9, 2025

(54) SHOOTING SIMULATOR SYSTEM AND CARTRIDGE

(71) Applicant: GAIM Immersive Technology Group AB, Malmö (SE)

(72) Inventor: Stephan ESKILANDER, Lund (SE)

(73) Assignee: GAIM Immersive Technology Group AB, Malmö (SE)

(21) Appl. No.: 18/864,669

(22) PCT Filed: May 11, 2023
(86) PCT No.: PCT/SE2023/050464

§ 371 Date: Nov. 11, 2024

(30) Foreign Application Priority Data
May 12, 2022 (SE) 2250573-9

(51) Int. Cl. F41G 3/26; F42B 8/08

(52) U.S. Cl. CPC F41G 3/2694; F42B 8/08

(57) ABSTRACT

A shooting simulator system (100) comprising a virtual reality, VR, headset (110), a positioning detector (115), a Bluetooth device (145) and an electrical cartridge (120) for use in a real firearm (125), wherein the electrical cartridge comprises: a hollow cartridge casing (500) arranged to fit a caliber of the real firearm (125), said casing forming an elongated chamber (527) containing an electrical switch device (529) along the interior of the casing (500); an actuator (530) arranged in a head section (505) of the casing (500) for controlling the electrical switch device (529) when the actuator (530) is activated by a firing mechanism of the real firearm (125); an electrical connector (560) arranged inside a neck portion (520) of the casing (500) and electrically connected to said electrical switch device (529), wherein said electrical connector (560) is accessible for detachable connection to a cable (150) via a mouth (525) of the casing (500) for external power supply by the Bluetooth device (145).

### TECHNICAL FIELD

The present disclosure relates to a shooting simulator system and cartridge, and more particularly, to a shooting simulator system and an electrical cartridge for real firearms.

### BACKGROUND

Hunters and other sportsmen as well as professional personnel usually train and practice their firing and shooting skills on a shooting range by using their hunting rifles, shotguns or any other real weapons loaded with live ammunition. Shooting ranges or galleries are usually arranged on remote locations, in general outside cities, which means that the hunter or sportsman usually has to drive to the shooting range with the rifle and ammunition in a vehicle. Moreover, using a weapon with live ammunition is expensive and always involves risks requiring necessary safety measures.

Therefore, it has been desired to provide shooting practice for home or other indoor training where shooters can fire simulated projectiles against simulated targets to improve targeting and shooting techniques for hunters and sportsmen. Different types of prior art target practice and aiming devices have been suggested to simulate the firing of a weapon. Such devices help train and instruct shooters by enabling them to practice aiming and shooting at targets indoors without actually making use of live ammunition.

U.S. Pat. No. 5,194,006 describes a training system and method for improving the skill and accuracy of shooting weapons, such as shotguns and rifles. The training system includes a stationary display screen for viewing a simulated moving target and a simulated projectile shot towards the target, and thereby takes up a lot of room. A light projector is mounted about the barrel of the weapon to optically project a simulated image and aiming point of the projectile upon the screen at the time when it exits the weapon. A target projector optically displays the moving target on the screen. A lens and light sensing device detects the position of the simulated projectile. A central processing unit (CPU) is operatively connected to the light sensing device and to a target position circuit to automatically calculate the positions of the projectile and target to indicate whether the target has been hit or missed and, if missed, by what distance.

U.S. Pat. No. 5,641,288 describes ballistic simulating and training system including a virtual reality head mounted display equipped with a screen for viewing a simulated moving target and a simulated projectile shot towards the target. A sensor unit operably associated with the head mounted display system produces an output signal representing the orientation of the head mounted display and, thus, the scene represented on the display screen of the head mounted display relative to a fixed reference location. Another sensor unit or apparatus is also operably associated with the head mounted display and produces a signal representing orientation of the weapon relative to the head mounted display system and, therefore, to the fixed location and furthermore the trajectory of the projectile. The fixed reference location is provided by projecting a pattern of light on a wall by a light projector. Although, a conventional firearm or weapon, such as a shotgun or rifle, is used, the weapon is unloaded and a simulated projectile is “fired” in response to manipulation of the trigger, which provides a less realistic experience for the user. The system comprises a number of modules in a rather complex set up, which take up a lot of space, which is undesirable.

US2017307333 describes a system and method for simulating lead of a target including a network, a simulation administrator connected to the network, a database connected to the simulation administrator, and a user device connected to the network. The user device includes a set of virtual reality unit, and a computer connected to the virtual reality unit and to the network. A set of position trackers are connected to the computer. A weapon is used with the simulation system. A trigger unit including a paddle is secured to a weapon with fasteners. Upon deflection of the paddle, the trigger unit sends electric signals utilized by the system. The trigger unit is in electronic communication with a simulation computer using a short range wireless communications protocol, such as Bluetooth. A positioning detector is fitted to the muzzle on the barrel of the weapon. A cable arranged freely along the outside of the weapon connects a USB port of the positioning detector to the trigger unit for communication of operational signals. This rather complex arrangement provides an unrealistic experience for the user and may easily break.

Alternatively, the weapon includes an electronic cartridge chambered in the weapon. The weapon further includes sensor arbor secured in the muzzle of the weapon. The electronic cartridge includes a micro slide switch in the rim section of the cartridge. The micro slide switch is operatively connected to a battery, which is operatively connected to a laser diode or an infrared LED. When activated, the laser diode emits a laser beam directed coaxial to the barrel of the weapon.

In use, the sensor arbor is threaded into the muzzle of the weapon. The laser radiation from the electronic cartridge is incident on a photo sensor of the arbor during operation of the system. The photo sensor sends a first signal to the processor which, in turn, sends an activation signal to the positioning detector. Such a complex system with a number of cooperating components requires individual power supply and may cause the system to stop working. Particularly, this type of intricate cartridge has the drawback of being easily damaged and requires integrated power supply.

Accordingly, a less complex, more reliable and durable shooting simulator system and associated cartridge providing a realistic user experience are desirable in the art.

### SUMMARY

It is an object of the teachings of this application to obviate at least some of the disadvantages discussed above, and to offer improvements in the technical field of shooting simulator systems and cartridges for use with real firearms.

In accordance with one aspect of the present disclosure, this is achieved by an electrical cartridge for use in a real firearm, wherein the electrical cartridge comprises: a hollow cartridge casing arranged to fit a caliber of the real firearm, said casing forming an elongated chamber containing an electrical switch device along the interior of the casing; an actuator arranged in a head section of the casing for controlling the electrical switch device when the actuator is activated by a firing mechanism of the real firearm; an electrical connector arranged inside a neck portion of the casing and electrically connected to said electrical switch device, wherein said electrical connector is accessible for detachable connection to a cable via a mouth of the casing for external power supply by an external device.

In some embodiments, the external device is a Bluetooth device of a shooting simulator system.

In some embodiments, a conducting path may be provided from a first contact of the phone connector via the switch device to a second contact of the phone connector when the actuator is activated by the firing mechanism of the real firearm.

In some embodiments, an actuator may be mounted for axial movement in a first portion of the elongated chamber being exposed at an open end of the head section of the electrical cartridge, wherein the actuator is provided with a peripheral flange and the first portion of the elongated chamber has a stepped shoulder forming a seat for the actuator, which is pressed against the seat by a first spring biasing element.

In some embodiments, the actuator may be an electrically conductive metal pin.

In some embodiments, actuator may be provided with an electrically conductive surface layer on the surface facing on to the interior of the casing.

In some embodiments, the electrical switch device comprises an electrical component or device arranged to provide a conducting path from the first contact of the phone connector via the first spring-loaded pin connector, the electrical component, and the second spring-loaded pin connector to the second contact of the phone connector in response to the actuator being brought into contact with two separate and electrically conductive areas, segments or pins of the electrical component or device.

In some embodiments, the electrical switch device may comprise a PCB, which is arranged in the casing for axial movement in the elongated chamber, wherein a first side of the PCB may be provided with a first conductive surface segment and a second conductive surface segment with an intermediate electrically insulating area; a second side of the PCB may be provided with a first circularly shaped conductive area with a circumferentially electrically insulating area, a second circularly shaped conductive area, and an intermediate circularly shaped non-conductive area, a first through wiring connecting the first conductive surface segment on the first side of the PCB with the first circularly shaped conductive area on the second side of the PCB, a second through wiring, which connects the second conductive surface segment on the first side of the PCB with the second circularly shaped conductive area on the second side of the PCB.

In some embodiments, a switch element of the switch device may be received within the elongated chamber, and is provided with a first spring-loaded pin connector and a second spring-loaded pin connector.

In some embodiments, the first and second spring-loaded pin connectors may be pogo pins.

In some embodiments, the first spring-loaded pin connector may be electrically connected to the first contact of the electrical connector and the second spring-loaded pin connector may be electrically connected to the second contact of the electrical connector.

In some embodiments, the electrical connector may be a phone or audio connector, having two, three, four, or five contacts or poles.

In some embodiments, the phone connector may be a female phone connector/socket adapted for receiving a male connector/plug having a diameter of 3.5 mm or 2.5 mm.

In some embodiments, the resistance of the first spring biasing element may be adapted to be overcome by the impact of a firing pin of a firing mechanism of the real firearm when the actuator is activated, thereby bringing the actuator into contact with both the first conductive surface segment and the second conductive surface segment of the PCB providing an electrical contact between the first conductive surface segment and the second conductive surface segment.

In some embodiments, the resistance of the second spring biasing element and the resistance of the first and second spring-loaded pin connectors are adapted to be overcome by the impact of the PCB being moved by the actuator when activated, wherein a conducting path may be provided from the first contact of the phone connector via the first spring-loaded pin connector, the PCB, and the second spring-loaded pin connector to the second contact of the phone connector. Advantageously, the impact of the firing pin may be absorbed and distributed between the spring biasing elements, so as to increase the endurance and reliability of the electrical cartridge.

In some embodiments, the head of the electrical cartridge has a cylindrical shape.

In some embodiments, actuator may be a dowel pin or plunger pin.

According to a second aspect, a Bluetooth device is provided for use with a shooting simulator system, wherein the Bluetooth device comprises a processor operatively connected to a memory, a battery, and an electrical connector, which is adapted for detachable connection to an electrical cartridge chambered in a real firearm via a cable through a barrel of the real firearm for external power supply of the electrical cartridge.

In some embodiments, the processor of the Bluetooth device may be configured to execute program instructions stored in the memory causing the Bluetooth device to detect an electrical signal at the electrical connector indicative of a shot signal generated in response to activation of the electrical cartridge.

In some embodiments, the processor of the Bluetooth device may be configured to execute program instructions stored in the memory causing the Bluetooth device to send a wireless shot signal in response to the detected electrical signal via the antenna to a wireless communication interface of a VR headset to cause an augmented reality or virtual reality event on an augmented reality or virtual reality display.

According to a third aspect, a shooting simulator system comprises a virtual reality, VR, headset, a positioning detector for attachment to a real firearm, a Bluetooth device for communication with the VR headset, and an electrical cartridge, wherein the electrical cartridge is connected to the Bluetooth device by means of a detachable cable running through a barrel of the real firearm.

An advantage of some embodiments of the present disclosure is an improved shooting simulator system and electrical cartridge for use with real firearms being less complex, more reliable and durable while providing a realistic user experience.

Other aspects and features of the invention and its embodiments are defined by the appended patent claims and are further explained, together with problems solved and advantages obtained, in the detailed description section as well as in the drawings.

It should be emphasized that the term “comprises/comprising” when used in this specification is taken to specify the presence of stated features, integers, steps, or components, but does not preclude the presence or addition of one or more other features, integers, steps, components, or groups thereof.

All terms used in the claims are to be interpreted according to their ordinary meaning in the technical field, unless explicitly defined otherwise herein. All references to “a/an/the element, device, component, means, etc are to be interpreted openly as referring to at least one instance of the element, device, component, means, etc., unless explicitly stated otherwise.

### BRIEF DESCRIPTION OF THE DRAWINGS

Exemplary embodiments is illustrated by way of example in the accompanying drawings in which like reference numbers indicate the same or similar elements and in which:

FIG. 1 is a perspective view of a shooting simulator system according to an embodiment and a firearm;

FIG. 2 is a block diagram of a virtual reality (VR) headset;

FIG. 3 is a block diagram of a positioning detector;

FIG. 4 is a block diagram of a Bluetooth device according to an embodiment;

FIG. 5A is a perspective view of an electrical cartridge according to an embodiment;

FIG. 5B is a cross-sectional view of the electrical cartridge taken through line VB-VB of FIG. 5A.

FIG. 6A is a top plan view of a PCB of the electrical cartridge in FIG. 5B; and

FIG. 6B is a bottom plan view of the PCB of the electrical cartridge in FIG. 5B.

### DESCRIPTION OF EMBODIMENTS

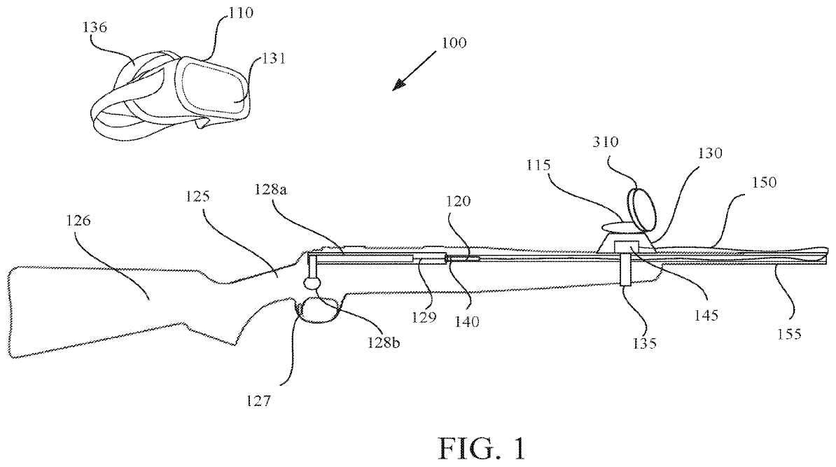

Embodiments of the invention will be described with reference to FIGS. 1-6, which all illustrate schematically an example arrangement according to some embodiments of the invention. Any equivalent variation and modification made according to appended claims are covered by the claims.

Reference will now be made to the figures to describe the embodiments in detail. The same reference signs are used for corresponding features in different figures.

Reference is made to FIG. 1, which is a perspective view of a shooting simulator system 100 including a virtual reality (VR) headset 110, a virtual reality tracker or positioning detector 115, and an electrical cartridge 120 for a real or conventional firearm 125. The positioning detector 115 may be arranged on a holder 130, which may be attached fastened to the firearm 125 by means of a fastener or strap 135. The electrical cartridge 120 may be inserted into a chamber 140 of the firearm 125. A Bluetooth device 145 may be arranged as an integrated unit of the holder 130 or as a separate unite. The electrical cartridge 120 may be connected to the Bluetooth device 145 by means of a cable 150 running through the barrel 155 of the firearm 125. Advantageously, the cable 150 is detachable from the electrical cartridge 120 and/or the Bluetooth device 145.

The real firearm for use in combination with the shooting simulator system 100 may be any real gun, weapon, rifle, such a hunting rifle, repeating rifle, shotgun, automatic or semi-automatic rifle, or small firearms, such as a handgun, wherein the electrical cartridge 120 may be fired by the conventional firing mechanism of the real firearm. In this embodiment, the firearm is a real bolt action hunting rifle comprising a stock 126, a trigger 127, trigger mechanism (not shown), bolt 128a with a bolt handle 128b, a firing pin 129, and the barrel 155. Advantageously, the real firearm may be completely unmodified for use in combination with the shooting simulator system 100. Particularly, the trigger and firing mechanisms, chamber, barrel or any other part of the firearm may be unchanged for use in combination with shooting simulator system 100.

The shooting simulator system 100 may be configured to simulate different kind of shooting scenarios including but not limited to, virtual hunting, marksmanship, skeet, trap, sporting clay shooting, bird or game shooting or any other virtual shooting environment. As illustrated in FIG. 1, the VR headset 110 comprises an augmented reality or virtual reality display 131 and straps 136 to fit about the head of a shooter.

The VR headset 110 may be, but is not limited to, the Pico Neo 3 pro/Pro Eye developed by Pico Immersive Pte. Ltd, the Oculus Quest 2 VR headset developed by Oculus, the HTC Vive Focus 3 headset available from HTC Corporation, or any augmented or virtual reality headset or unit in the art providing inside-out tracking, to immerse the shooter in a virtual hunting, marksmanship, skeet, trap, sporting clay shooting, bird or game shooting or any other virtual shooting environment. The VR headset 110 may be a standalone device that can run games and software wirelessly under an Android-based operating system or any other suitable operating system.

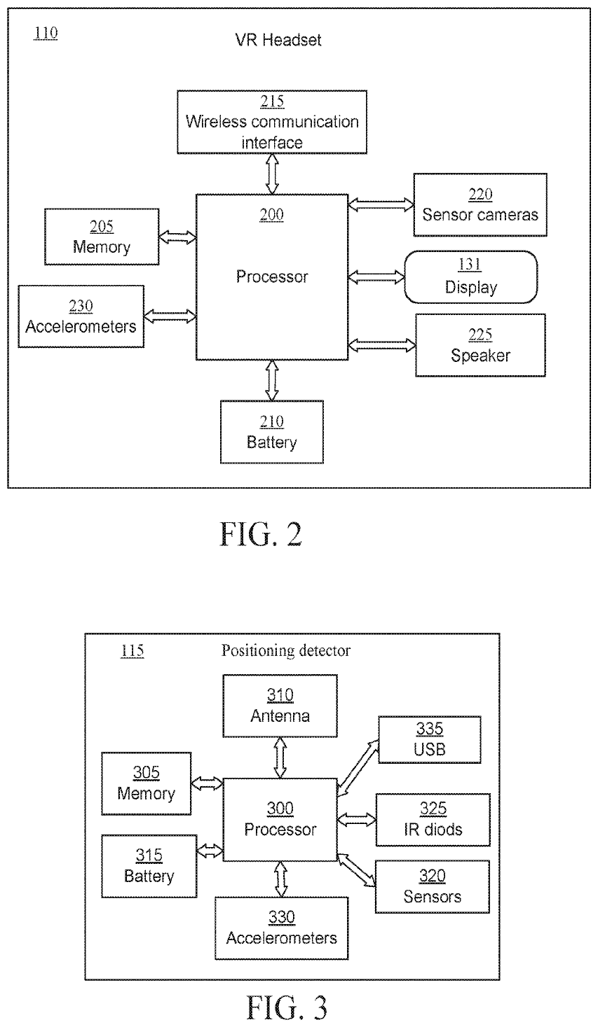

With reference to FIG. 2, a block diagram of the VR headset 110 is illustrated, including a processor 200 operatively connected to a memory 205, a battery 210, a wireless communication interface 215, the display 131, a set of wide-angle sensor cameras 220 arranged in the front of the display 131, a speaker 225, and one or more accelerometers 230.

Thereby, the VR headset 110 is arranged to provide computer capability and supports positional tracking, using the internal sensor cameras 220 in the front of the headset to spatially track the headset and the positioning detector 115.

Referring to FIG. 3, the positioning detector 115 may be, but is not limited to, an Oculus Touch controller, includes a processor 300 operatively connected to a memory 305, an antenna 310, a battery 315, sensors 320, IR diodes 325, accelerometers 330 and an USB port 335. The processor 300 is configured to execute instructions stored in the memory 305 that cause the positioning detector 115 to continuously measure its position and orientation using the sensors 320 and to broadcast its position and orientation by means of the antenna 310. The positioning detector 115 may communicate over a short range wireless connection, such as Bluetooth, to the VR headset 110.

The VR headset 110 is arranged to track the IR diodes 325 of the positioning detector 115 via the wide-angle cameras 220 built into the front of the headset. This is combined with accelerometer input from the VR headset 110 and the positioning detector 115, as well as AI algorithms to predict the path of motion when the controllers are outside of the cameras' field of view.

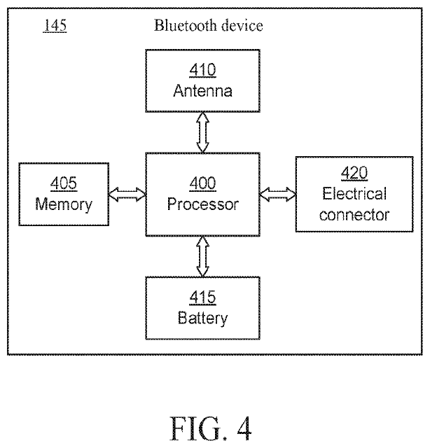

As illustrated in FIG. 4, the Bluetooth device 145 includes a processor 400 operatively connected to a memory 405, an antenna 410, a battery 415, and an electrical connector 420. The electrical connector 420 may be, but is not limited to, a phone or audio connector having two, three, four or five contacts or poles. In this embodiment of the Bluetooth device 145, the electrical connector 420 is a female connector/socket. In on embodiment, the female socket is adapted for receiving a male “mini” connector/plug having a diameter of 3.5 mm. In another embodiment, the female phone connector is adapted for connecting a male “sub-min” connector/plug having a diameter of 2.5 mm. In another embodiment, the Bluetooth device 145 may be proved with a first female phone connector adapted for connecting a male “mini” connector having a diameter of 3.5 mm and a second female phone connector is adapted for connecting a male “sub-min” connector having a diameter of 2.5 mm, wherein the first and the second female connectors are operatively connected to the processor 400 of the Bluetooth device 145.

The memory 405 is a computer-readable medium carrying computer instructions that when loaded into and executed by a controller of the processor 400 enables the Bluetooth device 145 to implement the operation of the Bluetooth device 145. Particularly, the processor 400 of the Bluetooth device 145 is configured to execute program instructions stored in the memory 405 causing the Bluetooth device to detect or sense an electrical signal at the electrical connector 420 indicative of a shot signal generated in response to that the electrical cartridge 120 has been activated, and to send a corresponding shot signal via the antenna 410 to the wireless communication interface 215 of the VR headset 110.

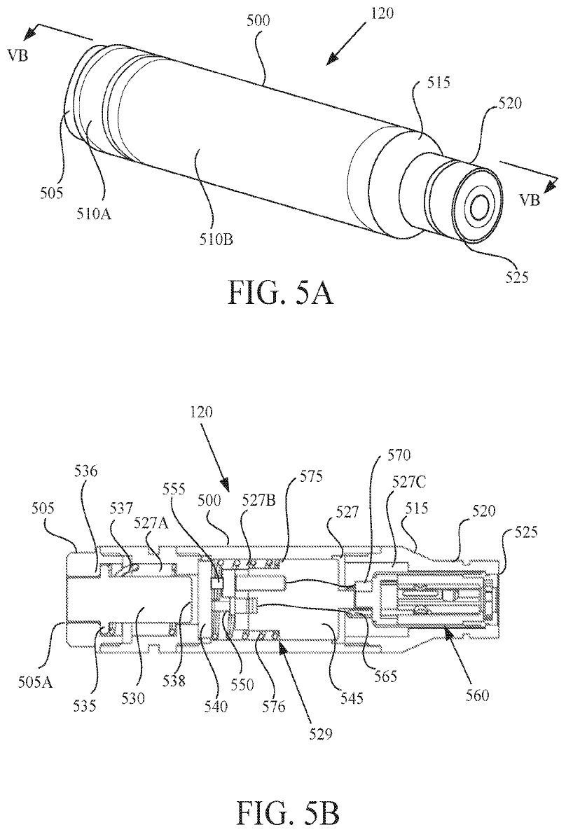

FIG. 5A shows the electrical cartridge 120 according to an embodiment, which comprises a cylindrical hollow cartridge casing 500. The casing 500 includes a head section 505, a first body section 510A, a second body section 510B, a shoulder section 515 with a neck 520 and mouth 525.

Preferably, each electrical cartridge may be arranged to fit a single specific caliber such as, but not limited to .22-250 Remington, .223 Remington, .243 Winchester, 6,5x55 Swedish Mauser, .308 Winchester, 30-06 Springfield, .300 Winchester Magnum, 458 Win. Mag or any other suitable caliber of a conventional firearm. In some embodiments the shape of the electrical cartridge may be used in firearms of similar calibers. Advantageously, the head section 505 of the electrical cartridge 120 may have an even cylindrical shape, i.e without any rim. The cylindrical head section prevents the electrical cartridge from being extracted when the bolt of a repeating rifle, such as a bolt action or lever action, is operated manually by a shooter, thereby readying the weapon to fire again.

FIG. 5B is a cross-sectional view of the electrical cartridge 120. The head section 505, first body section 510A, second body section 510B, and shoulder section 515 may be joined by threaded connections or glue joints, thereby forming an elongated chamber 527 for containing electrical and mechanical components forming an electrical switch device 529 along the interior of the casing 500.

The electrical switch device 529 may be operated or controlled by an actuator 530. In this embodiment, the actuator 530 may be, but is not limited to, a plunger pin or dowel pin, which is mounted for axial movement in a first portion 527A of the elongated chamber 527 to be exposed at an open end 505A of the head section 505 of the casing 500. The dowel pin 530 is provided with a peripheral flange 535 and the first potion 527A has a stepped shoulder 536 forming a seat for the dowel pin 530, which is pressed against the seat by a first spring biasing element 537. In this embodiment, the dowel pin 530 may be an electrically conductive metal pin. In another embodiment, the dowel pin 530 may be provided with an electrically conductive surface layer 538 on the surface facing on to the interior of the casing.

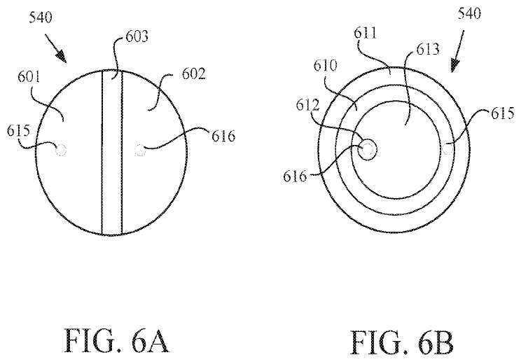

The electrical switch device 529 may comprise an electrical component, in this embodiment a PCB (printed circuit board) 540, which is arranged in the casing 500 between the first portion 527A and a second portion 527B of the elongated chamber 527. As illustrated in FIG. 6A, a first side of the PCB 540 is provided with a first conductive surface segment 601 and a second conductive surface segment 602 forming two circular segments with an intermediate electrically insulating area 603. In other embodiments, the first conductive surface segment and the second conductive surface segment may form other shapes, such as, but not limited to, squares, rectangles, circles or any other suitable shapes.

As illustrated in FIG. 6B, a second side of the PCB 540 is provided with a first conductive area 610 forming a circular area with a circumferentially electrically insulating area 611, a second conductive area 612 forming a circular area, and an intermediate non-conductive area 613 forming a circular area. In other embodiments, the first conductive area and the second conductive may be provided in other shapes, such as, but not limited to, squares, rectangles or any other suitable shape.

The PCB 540 is also provided with a first through wiring 615 connecting the first conductive surface segment 601 on the first side of the PCB 540 with the first circularly shaped conductive area 610 on the second side of the PCB 540. A second through wiring 616 is provided, which connects the second conductive surface segment 602 of the first side of the PCB 540 with the second circularly shaped conductive area 612 of the second side of the PCB 540.

Referring again to FIG. 5B, a switch element 545 of the switch device 529 is received within the second portion 527B of the elongated chamber 527. The switch element 545 is provided with a first pogo pin or spring-loaded pin connector 550 and a second pogo pin or spring-loaded pin connector 555.

Moreover, an electrical connector 560 is arranged in a third portion 527C of the elongated chamber 527, i.e inside the neck of the casing 500, being accessible for connection to a cable via the mouth 525 of the casing 500. The electrical connector 560 may be, but is not limited to, a “phone” or “audio” connector, having two, three, four or five contacts. In this embodiment the electrical connector 560 is a female phone connector/socket. In on embodiment, the female phone connector/socket is adapted for receiving a male “mini” connector/plug having a diameter of 3.5 mm. In another embodiment, the female phone connector/socket is adapted for receiving a male “sub-min” connector having a diameter of 2.5 mm. The electrical connector 560 is electrically connected to the switch element 545 of the switch device 529.

The first pogo pin 550 is electrically connected to a first contact 565 of the phone connector 560 and the second pogo pin 555 is electrically connected to a second contact 570 of the phone connector 560.

The switch element 545 is provided with a shoulder 575 forming a first seat for a first end of a second spring biasing element 576, which is pressed against the PCB 540 forming a seat for a second end of the second spring biasing element 576.

As illustrated in FIG. 1, the cartridge 120 may be connected to and arranged to communicate with the Bluetooth device 145 by means of the detachable cable 150 running through the barrel 155 of the firearm 125. When the cable 150 has been connected to electrical connector 560 of the cartridge 120 and the electrical connector 420 of the Bluetooth device 145, the electrical cartridge 120 may be inserted into the firearm 125 in a conventional manner. In this embodiment, the cable 150 may be, but is not limited to, a male to male 3.5 mm phone/audio cable. The male plug may have two, three, or four contacts/poles. In another embodiment, the male phone connector may be a “sub-min” connector/plug having a diameter of 2.5 mm.

Advantageously, the electrical cartridge 120 is provided with an external power supply via the cable 150, in this embodiment, by means of the internal battery 415 of Bluetooth device 145.

The shooting simulator system 100 is made ready for use by establish connection between the different devices of the system including pairing the VR headset 110 with the positioning detector 115, and pairing the VR headset 110 with the Bluetooth device 145.

When the trigger 127 of the firearm 125 is pulled, the trigger mechanism of the firearm 125 is activated, wherein the firing pin 129 of the firearm will contact the dowel pin 530. The impact of the firing pin 129 overcomes the resistance of the first spring biasing element 537 bringing the conductive surface layer 538 of the dowel pin 530 into contact with both the first conductive surface segment 601 and the second conductive surface segment 602 of the PCB 540, thereby establish an electrical contact between the two segments 601 and 602.

Moreover, the impact of the firing pin 129 also overcomes the resistance of the second spring biasing element 576 and the resistance of the first and second spring-loaded pin connectors 550 and 555, when the PCB 540 is moved axially by the dowel pin 530. In this position, a conducting path is provided from the first contact 565 of the phone connector 560 via the first spring-loaded pin connector 550, the PCB 540, and the second spring-loaded pin connector 555 to the second contact 570 of the phone connector 560. Advantageously, the impact of the firing pin is absorbed and distributed between the first spring biasing element 537, first and second spring loaded pin connectors 550 and 555, and the second spring biasing element 576. Thereby, the endurance and reliability of the electrical cartridge is increased.

The battery 415 of the Bluetooth device 145 provides current to the cable 150 connecting the Bluetooth device 145 to the electrical connector 560 of the electrical cartridge 120. Hence, a complete closed circuit is established through the electrical cartridge 120 and the Bluetooth device 145, wherein a detectable electrical signal is generated in response to the trigger 127 being pulled by a user of the firearm 125 of the shooting simulator system 100.

As described above, the processor 400 of the Bluetooth device 145 is configured to execute program instructions stored in the memory 405 causing the Bluetooth device to detect or sense the electrical signal at the electrical connector 420 indicative of a shot signal generated in response to that the electrical cartridge 120 has been activated, and to send a corresponding shot signal via the antenna 410 to the wireless communication interface 215 of the VR headset 110. Thereby, the shooting simulator system 100 may be configured to detect or sense an electrical signal indicative of a shot signal generated in response to that the electrical cartridge 120 has been activated in response to a pulled trigger 127 of the firearm 125 in different kind of simulated shooting scenarios including but not limited to, virtual hunting, marksmanship, skeet, trap, sporting clay shooting, bird or game shooting or any other virtual shooting environment.

Advantageously, the shooting simulator system 100 can be easily moved to be used with different kind of firearms. The electrical cartridge 120 may be removed from the chamber 140, the cable 150 can be disconnected from the electrical cartridge 120 and/or the Bluetooth device 145. The Bluetooth device and the positioning detector 115 may be released from the firearm for attachment to another firearm. Again, the cartridge 120 may be connected to and arranged to communicate with the Bluetooth device 145 by means of the cable 150 running through a barrel of the another firearm. When the cable 150 has been connected to the cartridge 120 and the Bluetooth device 145, the electrical cartridge 120 may be inserted into the other firearm in a conventional manner.

The features and advantages of the invention are apparent from the detailed specification, and thus it is intended by the appended claims to cover all such features and advantages of the invention, which fall within the scope of the technology. For example, the detectable electrical signal generated in response to the trigger being pulled by a user of the firearm of the shooting simulator system may be used for controlling different functions of the simulation system, for example, but not limited to, simulating a firing or selecting different menu items in different kind of simulated shooting scenarios including but not limited to, virtual hunting, marksmanship, skeet, trap, sporting clay shooting, bird or game shooting or any other virtual shooting environment.

Other configurations are possible within the scope of the present patent claims. However, although embodiments of the shooting simulator system and electrical cartridge have been illustrated in the accompanying drawings and described in the foregoing detailed description, the disclosure is illustrative only, and changes, modifications and substitutions may be made without departing from the scope of the technology as set forth and defined by the following claims.

For example, the electrical component 540 has been described as a PCB, which is arranged in the casing 500 between the first portion 527A and a second portion 527B of the elongated chamber 527. However, the electrical component 540 may be any suitable electrical component or device arranged to provide a conducting path from the first contact 565 of the phone connector 560 via the first spring-loaded pin connector 550, the electrical component 540, and the second spring-loaded pin connector 555 to the second contact 570 of the phone connector 560 in response to the dowel pin 530 being brought into contact with two separate and electrically conductive areas, segments or pins of the electrical component 540, preferably but not limited to copper or any other suitable metal.

In one embodiment, the electrical component or device 540 may be a plastic element provided with a conducting rubber dome facing the dowel pin 530 and conducting elements, such as, but not limited to, brass or aluminium pins in connection with the first and second spring-loaded pin connectors 550, 555. When the firearm is fired, i.e the trigger 127 is pulled, the conducting rubber dome may be compressed by the moving dowel pin 530 and thereby establishing a conducting path from the first contact 565 to the second contact 570 of the phone connector 560.

Hence, it should be understood that the limitations of the described embodiments are merely for illustrative purpose and by no means limiting. Instead, the scope of the technology is defined by the appended claims rather than by the description, and all variations that fall within the range of the claims are intended to be embraced therein.

In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. An electrical cartridge for use in a real firearm, wherein the electrical cartridge comprises:
a hollow cartridge casing arranged to fit a caliber of the real firearm, said casing forming an elongated chamber containing an electrical switch device along the interior of the casing; an actuator arranged in a head section of the casing for controlling the electrical switch device when the actuator is activated by a firing mechanism of the real firearm; an electrical connector arranged inside a neck portion of the casing and electrically connected to said electrical switch device, wherein said electrical connector is accessible for detachable connection to a cable via a mouth of the casing for external power supply by an external device, wherein the cartridge is connectable to and arranged to communicate with the external device by means of the detachable cable running through a barrel of the firearm.

2. The electrical cartridge according to claim 1, wherein the electrical cartridge is connectable to and arranged to communicate with the external device comprising a Bluetooth device of a shooting simulator system.

3. The electrical cartridge according to claim 1, wherein a conducting path is provided from a first contact of the electrical connector via the switch device to a second contact of the electrical connector when the actuator is activated by the firing mechanism of the real firearm.

4. The electrical cartridge according to claim 1, wherein the actuator is mounted for axial movement in a first portion of the elongated chamber being exposed at an open end of the head section of the electrical cartridge, wherein the actuator is provided with a peripheral flange and the first portion of the elongated chamber has a stepped shoulder forming a seat for the actuator, which is pressed against the seat by a first spring biasing element.

5. The electrical cartridge according to claim 4, wherein the actuator is an electrically conductive metal pin.

6. The electrical cartridge according to claim 4, wherein the actuator is provided with an electrically conductive surface layer on the surface facing a PCB within the interior of the casing.

7. The electrical cartridge according to claim 3, wherein the electrical switch device comprises an electrical component or device arranged to provide the conducting path from the first contact of the electrical connector via a first spring-loaded pin connector of the switch device, the electrical component, and a second spring-loaded pin connector of the switch device to the second contact of the electrical connector in response to the actuator being brought into contact with two separate and electrically conductive areas, segments or pins of the electrical component or device.

8. The electrical cartridge according to claim 7, wherein the electrical component is a PCB, which is arranged in the casing for axial movement in the elongated chamber, wherein a first side of the PCB is provided with a first conductive surface segment and a second conductive surface segment with an intermediate electrically insulating area; a second side of the PCB is provided with a first circularly shaped conductive area with a circumferentially electrically insulating area, a second circularly shaped conductive area, and an intermediate circularly shaped non-conductive area, a first through wiring connecting the first conductive surface segment on the first side of the PCB with the first circularly shaped conductive area on the second side of the PCB, a second through wiring, which connects the second conductive surface segment on the first side of the PCB with the second circularly shaped conductive area on the second side of the PCB.

9. The electrical cartridge according to claim 8, wherein a switch element of the switch device is received within the elongated chamber, and is provided with a first spring-loaded pin connector and a second spring-loaded pin connector.

10. The electrical cartridge according to claim 9, wherein the first and second spring-loaded pin connectors are pogo pins.

11. The electrical cartridge according to claim 9, wherein the first spring-loaded pin connector is electrically connected to the first contact of the electrical connector and the second spring-loaded pin connector is electrically connected to the second contact of the electrical connector.

12. The electrical cartridge according to claim 1, wherein the electrical connector is a phone or audio connector, having two, three, four or five contacts or poles.

13. The electrical cartridge according to claim 12, wherein the phone connector is female phone connector/socket adapted for receiving a male connector/plug having a diameter of 3.5 mm or 2.5 mm.

14. The electrical cartridge according to claim 9, wherein the resistance of the first spring biasing element is adapted to be overcome by the impact of a firing pin of the firing mechanism of the real firearm when the actuator is activated, thereby bringing the actuator into contact with both the first conductive surface segment and the second conductive surface segment of the PCB providing an electrical contact between the first conductive surface segment and the second conductive surface segment.

15. The electrical cartridge according to claim 14, wherein the resistance of a second spring biasing element and the resistance of the first and second spring-loaded pin connectors and are adapted to be overcome by the impact of the PCB being moved by the actuator when activated, wherein a conducting path is provided from the first contact of the phone connector via the first spring-loaded pin connector, the PCB, and the second spring-loaded pin connector to the second contact of the phone connector.

16. (canceled)

17. The electrical cartridge according to claim 1, wherein the actuator is a dowel pin or plunger pin.

18. A Bluetooth device for use with a shooting simulator system, said Bluetooth device comprising:
a processor operatively connected to a memory, a battery, and an electrical connector, which is adapted for detachable connection to and external power supply of an electrical cartridge according to claim 1 of a real firearm via a cable.

19. The Bluetooth device according to claim 18, wherein the processor is configured to execute program instructions stored in the memory causing the Bluetooth device to detect an electrical signal at the electrical connector indicative of a shot signal generated in response to activation of the electrical cartridge.

20. The Bluetooth device according to claim 19, wherein the processor is configured to execute program instructions stored in the memory causing the Bluetooth device to send a wireless shot signal in response to the detected electrical signal via the antenna to a wireless communication interface of a VR headset to cause an augmented reality or virtual reality event on an augmented reality or virtual reality display.

21. A shooting simulator system, comprising a virtual reality, VR, headset, a positioning detector for attachment to a real firearm, a Bluetooth device and an electrical cartridge,
wherein the electrical cartridge comprises a hollow cartridge casing arranged to fit a caliber of the real firearm, said casing forming an elongated chamber containing an electrical switch device along the interior of the casing; an actuator arranged in a head section of the casing for controlling the electrical switch device when the actuator is activated by a firing mechanism of the real firearm; an electrical connector arranged inside a neck portion of the casing and electrically connected to said electrical switch device, wherein said electrical connector is accessible for detachable connection to a cable via a mouth of the casing for external power supply by an external device, wherein the cartridge is connectable to and arranged to communicate with the external device by means of the detachable cable running through a barrel of the firearm
wherein the Bluetooth device comprises a processor operatively connected to a memory, a battery, and an electrical connector, which is adapted for detachable connection to and external power supply of the electrical cartridge, and
wherein the electrical cartridge is connected to the Bluetooth device by means of a detachable cable running through a barrel of the real firearm.
